(19) United States
(12) Patent Application Publication
(10) Pub. No.: US 2007/0158463 A1
(43) Pub. Date: Jul. 12, 2007

(54) Liquid spraying device with return-preventing structure

(76) Inventor: Mey-Chu Lan, Taipei Hsien (TW)

Correspondence Address: MEY-CHU LAN, 235 Chung-Ho, Box 8-24, Taipei, TW

(21) Appl. No.: 11/324,385

(22) Filed: Jan. 4, 2006

(51) Int. Cl. A62C 13/62; B05B 9/047; A62C 31/02

(52) U.S. Cl. 239/302; 239/589; 239/323

(57) ABSTRACT

A liquid spraying device with a return-preventing structure comprises a receiving chamber having an inner tube; a front end of the receiving chamber being formed with a spraying mouth; a tapered section being formed between the spraying mouth and a front end of the liquid chamber; an elastic body being annularly installed on an inner wall of the inner tube; a gap being formed between the elastic body and the inner tube; a front end of the elastic body being filled with liquid; a valve being installed between the liquid chamber and the expansion chamber; a base having an actuation portion; and a pad at an edge of the liquid chamber near the connection of the tapered section and the liquid chamber; the pad being installed between the elastic body and the wall of the inner tube.

### FIELD OF THE INVENTION

The present invention relates to burglar proof device, and in particular to a liquid spraying device with a return-preventing structure, wherein a flexible pad is installed at a predetermined position of the receiving chamber so that the spraying liquid only flows along a single path. It will not return to the gap between the receiving chamber and an elastic body so that the ejection coverage of the liquid can be increased.

### BACKGROUND OF THE INVENTION

To protect the safety of human bodies, some burglar-proof liquid spraying devices are developed. It uses the same principle as the insect killer sprayers. Liquid is sprayed out from a spraying head. However the spraying coverage is small and is affected by wind. Thereby it is not a preferred design.

Referring to FIG. 1, a prior art burglar-proof device is illustrated prior art device 3 has a container 31 and a base 32. An elastic body with liquid 41 installed therein is installed within the container 31. The base 32 is installed with a punching unit 33. An ejection key (not shown) is pressed to drive a linkage so that the punching unit 33 of the base 32 will eject the elastic body 4 of the container 31 to force the liquid 41 of the ejection device 4 to spray out to have the affect of burglar-proof.

The above mentioned prior art structure is reusable. After use, the container 31 and the base 32 is openable for refilling a new elastic body. However the liquid 41 will return back to a gap 313 between the elastic body 4 and the container 31 so as to pollute the container 31 and the elastic body 4, even the liquid flows back to the base 32. Thereby the elastic body 4 is impure. For a longer time, dirt will accumulate in the container 31 so that it is difficult to fill the elastic body 4. Thus prior art is not practical. Furthermore, the liquid 41 is possible to hurt people.

### SUMMARY OF THE INVENTION

Accordingly, the primary object of the present invention is to provide a liquid spraying device with a return-preventing structure, wherein a flexible pad is installed at a predetermined position of the receiving chamber so that the spraying liquid only flows along a single path. It will not return to the gap between the receiving chamber and an elastic body so that the ejection coverage of the liquid can be increased.

To achieve above objects, the present invention provides a liquid spraying device with a return-preventing structure which comprises a receiving chamber having an inner tube; a front end of the receiving chamber being formed with a spraying mouth; a tapered section being formed between the spraying mouth and a front end of the liquid chamber; an elastic body being annularly installed on an inner wall of the inner tube; a gap being formed between the elastic body and the inner tube; a rear end of the elastic body being formed with an expansion chamber; reagents being filled in the expansion chamber; a front end of the elastic body being filled with liquid filled in the front end of the elastic body; a valve being installed between the liquid chamber and the expansion chamber; a base having an actuation portion which is formed of a push rod, a punching unit and a stud; when the push rod being pushed by a spring, the punching unit will punch forwards rapidly so that the reagents in the expansion chamber reacts; thus, the valve compressing the liquid to break the front end of the elastic body; the liquid will spray out from a spraying mouth; and a pad at an edge of the liquid chamber near the connection of the tapered section and the liquid chamber; the pad being installed between the elastic body and the wall of the inner tube so that the pad is compressed by the elastic body to deform; thereby when liquid sprays out from the spraying mouth, the pad will isolate the gap so that the liquid will not return to the gap.

The various objects and advantages of the present invention will be more readily understood from the following detailed description when read in conjunction with the appended drawing.

### BRIEF DESCRIPTION OF THE DRAWINGS

FIG. 1 is a schematic view about the body safety device of the prior art.

FIG. 2 shows the first embodiment of the liquid spraying device with a return-preventing structure of the present invention.

FIG. 3 shows the detailed schematic view about the operation of the FIG. 2 before the pad is compressed.

FIG. 4 shows a schematic view about the operation of FIG. 2 after the pad is compressed.

FIG. 5 is a structural view about the second embodiment of the present invention.

FIG. 6 is a schematic view about the liquid spraying device with a return-preventing structure of the present invention before compression.

FIG. 7 is a schematic view about the liquid spraying device with a return-preventing structure of the present invention after compression.

FIG. 8 shows the third embodiment of the liquid spraying device with a the return-preventing structure of the present invention.

FIG. 9 is a schematic view about the liquid spraying device with the return-preventing structure of FIG. 8 before compression.

FIG. 10 is a schematic view about the liquid spraying device with the return-preventing structure of FIG. 9 after compression.

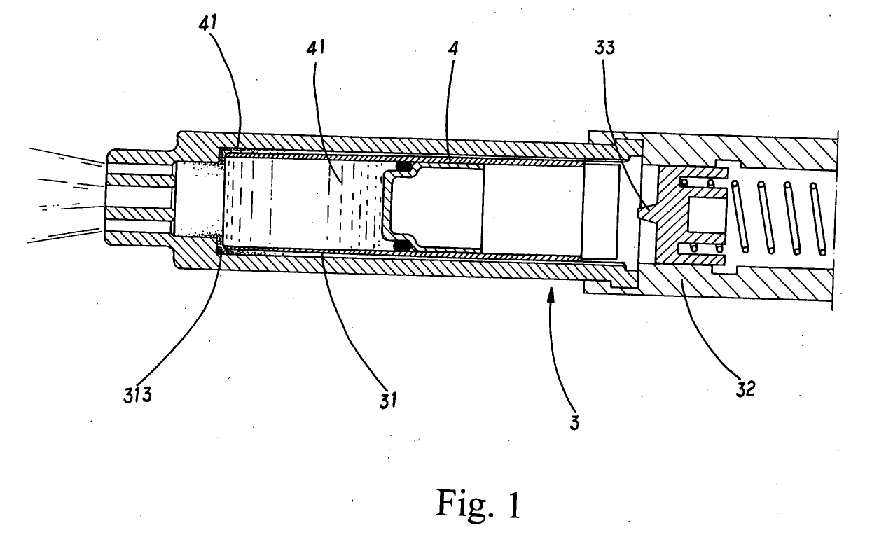

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

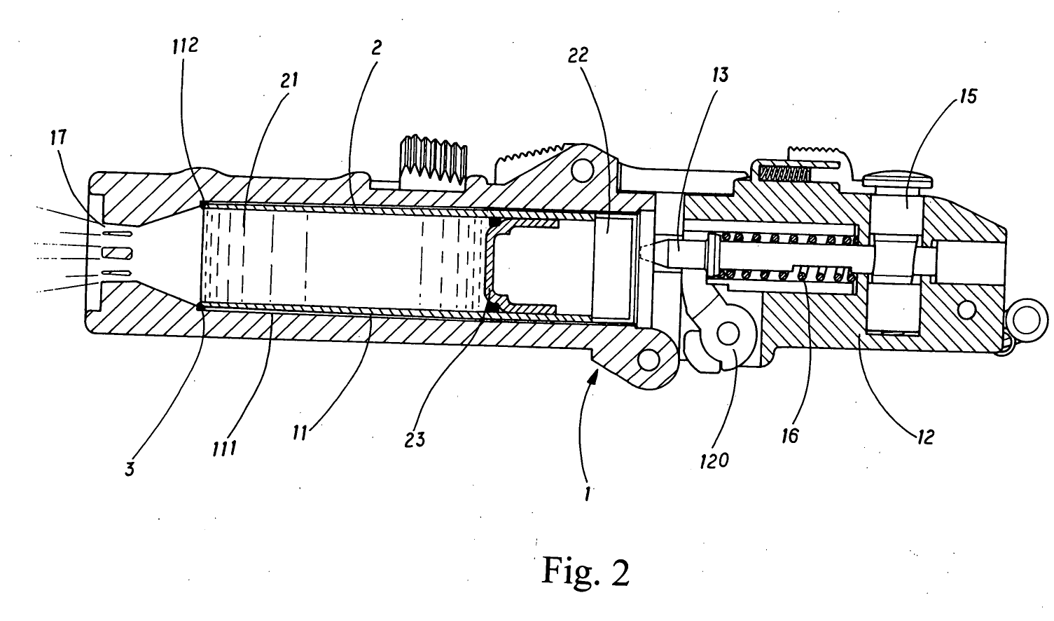

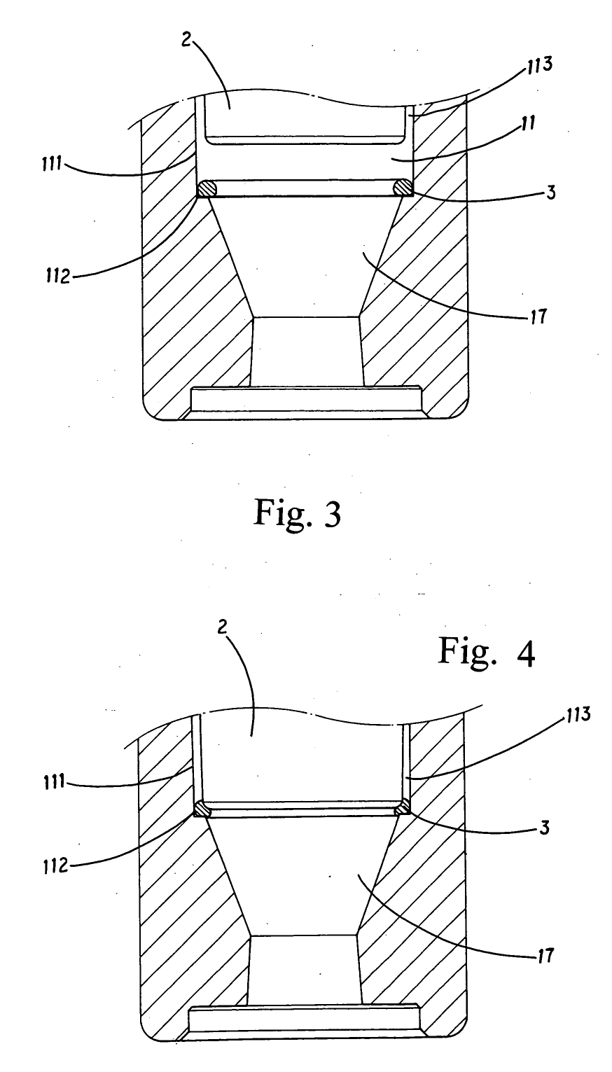

Referring to FIG. 2 to 4, the first embodiment of the present invention is illustrated. The liquid spring device 1 has the following components.

A receiving chamber 11 has an inner tube 111. A front end of the receiving chamber 11 is formed with an ejecting mouth 17. A tapered section is formed between the spraying mouth 17 and the front end of the liquid chamber 21. An elastic body 2 is annularly installed on an inner wall of the inner tube 111. A gap 113 (see FIG. 4) is formed between the elastic body 2 and the inner tube 111. A rear end of the elastic body 2 is formed with an expansion chamber 22. Reagents (or drugs) are filled in the expansion chamber 22. A front end of the elastic body 2 is filled with liquid. A valve 23 is installed between the liquid chamber 21 and the expansion chamber 22.

A base 12 has an actuation portion which includes a push rod 120, a punching unit 13 and a stud 15. When the push rod 120 is pushed by a spring 16, the punching unit 13 will punch forwards rapidly so that the reagents (or drugs) in the expansion chamber 22 reacts. Thus, the valve 23 compresses the liquid to break the front end of the elastic body 2. The liquid 21 will spray out from a spraying mouth 17.

A pad 3 is at an edge of the liquid chamber 12 near the connection of the tapered section and the liquid chamber 21. The pad is installed between the elastic body 2 and the wall of the inner tube 111 so that the pad 3 is compressed by the elastic body 2 to deform. Thereby when liquid sprays out from the spraying mouth 17, the pad 3 will isolate the gap 113 so that the liquid will not return to the gap 113.

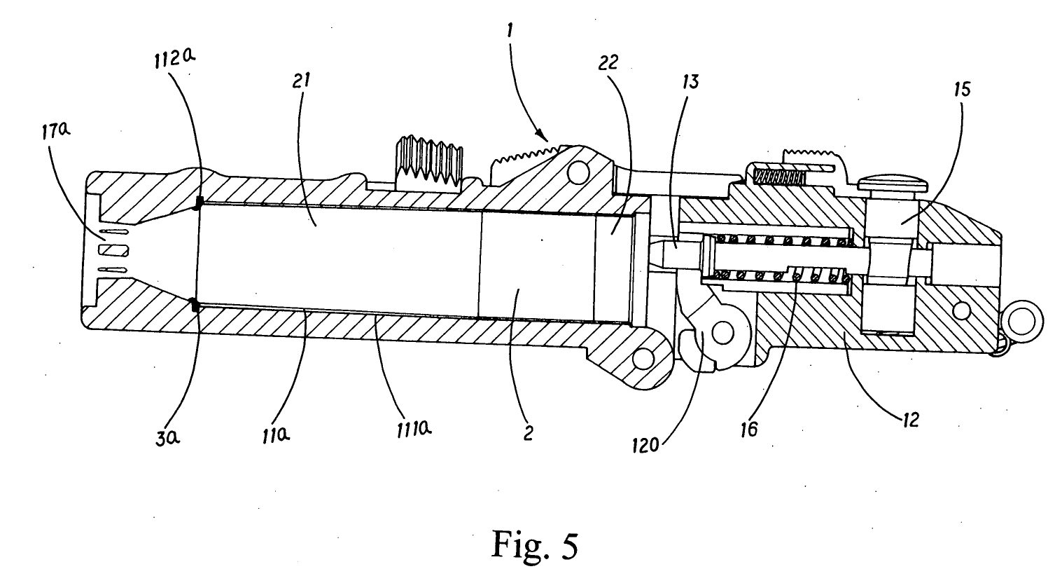

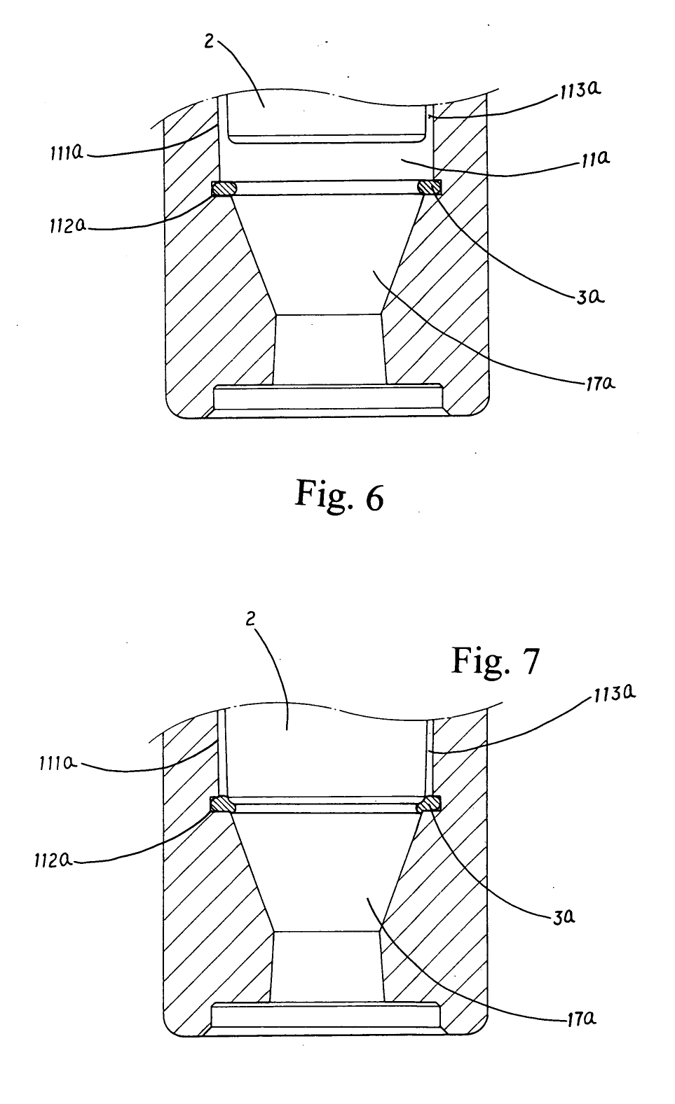

Referring to FIGS. 5 to 7, the second embodiment of the present invention will be described herein. To make the pad 3a steady, a recess 112a is formed at a front end of the liquid chamber 21 near the tapered section at the front end of the inner tube 111a and of the receiving chamber 11a. A part of the pad 3a is embedded into the recess 112a and a part thereof exposes out of the recess 112a. Thereby when the liquid sprays out from the spraying mouth 17s, the liquid will not flow back to the gap 113a between the elastic body 2 and the inner tube 111a.

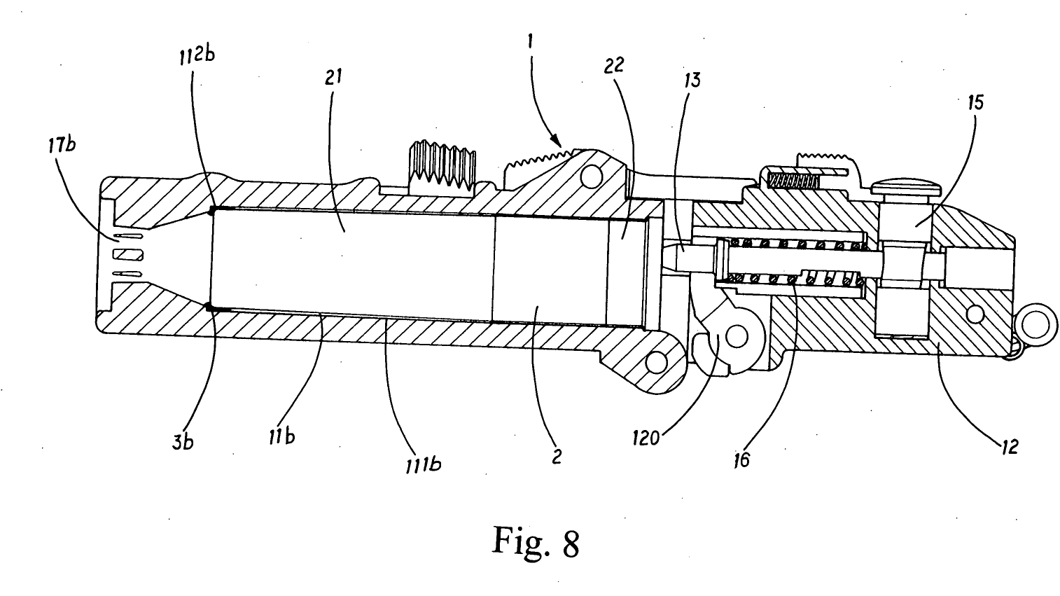

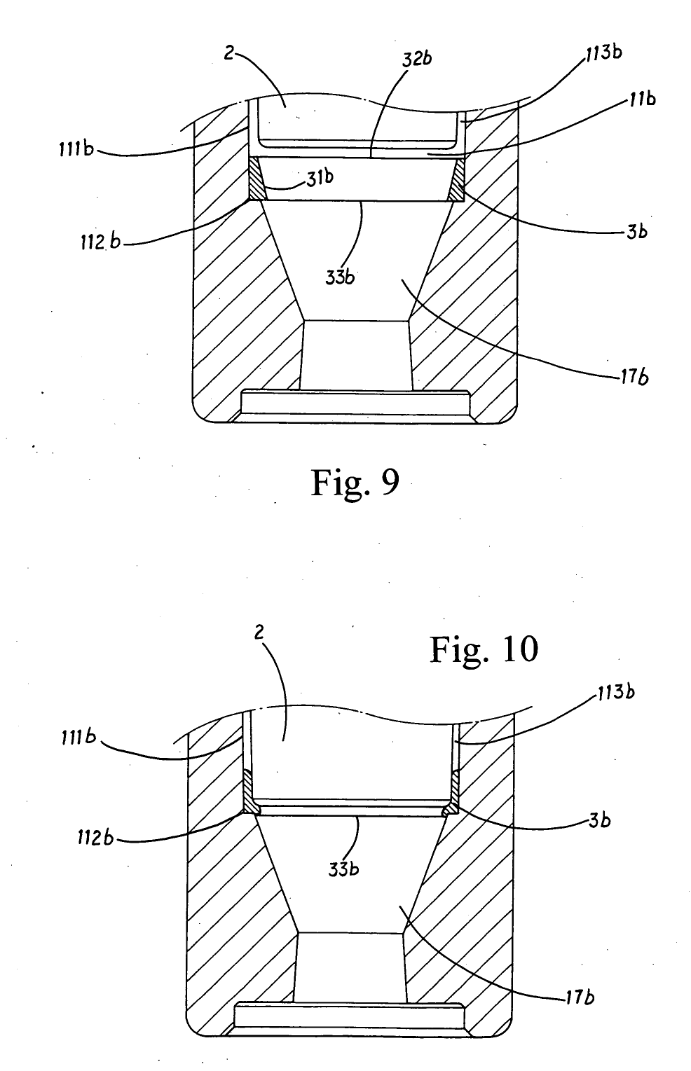

Referring to FIGS. 8 to 10, the second embodiment of the present invention is illustrated. The pad 3b is installed at a front end of the inner tube 111b of the receiving chamber 11b and near a tapered section of the spraying mouth 17b. Referring to FIG. 9, an inner side of the pad 3b is an inclined surface. When the liquid is sprayed out of a surface 32b to pass through the surface 33b and then is sprayed out from the spraying mouth 17. The liquid will not return back to the gap between the elastic body 2 and a wall of the inner tube 111.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A liquid spraying device with a return-preventing structure comprising:
a receiving chamber having an inner tube; a front end of the receiving chamber being formed with a spraying mouth; a tapered section being formed between the spraying mouth and a front end of the liquid chamber; an elastic body being annularly installed on an inner wall of the inner tube; a gap being formed between the elastic body and the inner tube; a rear end of the elastic body being formed with an expansion chamber; reagents or drugs being filled in the expansion chamber; a front end of the elastic body being filled with liquid; a valve being installed between the liquid chamber and the expansion chamber;
a base having an actuation portion which is formed of a push rod, a punching unit and a stud; when the push rod being pushed by a spring, the punching unit will punch forwards rapidly so that the reagents in the expansion chamber reacts; thus, the valve compressing the liquid to break the front end of the elastic body; the liquid will spray out from a spraying mouth; and
a pad at an edge of the liquid chamber near the connection of the tapered section and the liquid chamber; the pad being installed between the elastic body and the wall of the inner tube so that the pad is compressed by the elastic body to deform; thereby when liquid sprays out from the spraying mouth, the pad will isolate the gap so that the liquid will not return to the gap.

2. The liquid spraying device with a return-preventing structure as claimed in claim 1, wherein the pad is annularly arranged at a wall of the inner tube.

3. The liquid spraying device with a return-preventing structure as claimed in claim 1, wherein the pad is flexible.

4. The liquid spraying device with a return-preventing structure as claimed in claim 1, wherein a recess is formed at a front end of the liquid chamber near the tapered section at the front end of the inner tube and of the receiving chamber; a part of the pad is embedded into the recess and a part thereof exposes out of the recess.

5. The liquid spraying device with a return-preventing structure as claimed in claim 4, wherein the pad is annularly arranged at a wall of the inner tube.

6. The liquid spraying device with a return-preventing structure as claimed in claim 5, wherein the pad is flexible.

7. The liquid spraying device with a return-preventing structure as claimed in claim 1, wherein the pad is installed at a front end of the inner tube of the receiving chamber and near a tapered section of the spraying mouth, an inner side of the pad is an inclined surface.

8. The liquid spraying device with a return-preventing structure as claimed in claim 7, wherein the pad is flexible.
